(19) United States
(12) Patent Application Publication
(10) Pub. No.: US 2022/0352497 A1
(43) Pub. Date: Nov. 3, 2022

(54) BATTERY WITH SULFUR-CONTAINING ELECTRODE

(71) Applicants: Sanpei ZHANG, Downers Grove, IL (US); Zheng LI, Blacksburg, VA (US)

(72) Inventors: Sanpei ZHANG, Downers Grove, IL (US); Zheng LI, Blacksburg, VA (US)

(21) Appl. No.: 17/621,458

(22) PCT Filed: Jun. 21, 2020
(86) PCT No.: PCT/US2020/038866

§ 371 Date: Dec. 21, 2021

Related U.S. Application Data
(60) Provisional application No. 62/864,953, filed on Jun. 21, 2019.

(51) Int. Cl. H01M 4/136; H01M 4/134; H01M 4/04; H01M 10/0569; H01M 4/62

(52) U.S. Cl. CPC H01M 4/136; H01M 4/134; H01M 4/0471; H01M 10/0569; H01M 4/623; H01M 2300/0028

(57) ABSTRACT

A variety of batteries are provided having a sulfur-containing cathode; a metal anode; and an electrolyte between the cathode and the anode, wherein the electrolyte is capable of solvating metal ions produced from the metal anode, polysulfide species produced from the sulfur containing cathode, and dissolved oxygen species. In some aspects, the batteries include a separator separating the battery into a cathode region nearest the cathode and an anode region nearest the anode, wherein the separator permits permeability of the electrolyte and the metal ions. Methods of using and batteries are also provided. In some aspects, the batteries are capable of charge/discharge cycles in excess of 10, 100, or 1000 cycles.

### CROSS-REFERENCE TO RELATED APPLICATIONS

This application claims priority to, and the benefit of, co-pending U.S. provisional application entitled “BATTERY WITH SULFUR-CONTAINING ELECTRODE” having Ser. No. 62/864,953, filed Jun. 21, 2019, the contents of which are incorporated by reference in their entirety.

### TECHNICAL FIELD

The present disclosure generally relates to battery technologies.

### BACKGROUND

Electrochemical battery systems are promising energy storage technologies that would transform global energy supply and meet long-term performance and cost requirements, but more advances in storage density and costs need to be made. For example, some estimate that for electric transportation, the battery system-level energy density must exceed 400 Wh/kg and cost less than $150/kWh to allow electric vehicles to compete with traditional gas-powered vehicles. For grid energy storage, a system-level cost of $100/kWh with less stringent energy density requirement is targeted to enable affordability for both commercial and residential use. Today's lithium-ion batteries (˜200 Wh/kg and $300/kWh) can hardly meet these requirements. Another concern is that the availability of the elements used in the electrode couples of the lithium-based batteries put resource constraints on the scale-up of battery production and the wider adoption of battery technology. Therefore, new high-energy density battery systems using abundant and low-cost materials are needed to meet these challenges.

There remains a need for improved battery technologies that overcome the aforementioned deficiencies.

### SUMMARY

A variety of battery technologies are provided that overcome one or more of the aforementioned deficiencies. In some aspects, a battery is provided having a sulfur-containing cathode; a metal anode; and an electrolyte between the cathode and the anode, wherein the electrolyte is capable of solvating metal ions produced from the metal anode, polysulfide species produced from the sulfur-containing cathode, and dissolved oxygen species.

The sulfur-containing cathode can be porous so as to allow oxygen gas to enter the battery. The sulfur-containing cathode can also be non-porous to oxygen gas, e.g. where the electrolyte is saturated with oxygen prior to use and then replenished after use. Solvated oxygen can be introduced into the cathode region by injecting oxygen in the sulfur-containing cathode, saturating the electrolyte with oxygen gas, both, or by any other suitable approach. In some aspects, the solvated oxygen concentration is more than 10⁻⁵ mol/L, e.g. about 10⁻⁵ mol/L to about 10⁻⁴ mol/L, about 10⁻⁵ mol/L to about 10⁻³ mol/L, about 10⁻⁵ mol/L to about 10⁻² mol/L, or about 10⁻⁴ mol/L to about 10⁻² mol/L.

In some aspects, the battery includes a separator separating the battery into a cathode region nearest the cathode and an anode region nearest the anode, wherein the separator permits permeability of the electrolyte and the metal ions. In some aspects, the battery does not need a separator since the reactions can in some instances completely eliminate sulfur crossover, which can provide for cost savings.

The sulfur-containing cathode can include a carbon electrode impregnated with sulfur on an outer surface of the carbon electrode. In some aspects, the sulfur-containing cathode is made by a process including casting a slurry onto a solid substrate to form a film, the slurry having sulfur, carbon, and a polymer binder in a suitable solvent; and then drying the film at an elevated temperature to form the sulfur-containing cathode. In some aspects, the slurry has a sulfur/carbon composite and binder solution mass ratio of about 1:1 to about 3:1. In some aspects, the solvent is selected from the group consisting of diethylene glycol dimethyl ether, triethylene glycol dimethyl ether, tetraethylene glycol dimethyl ether, diethylene glycol diethyl ether, diethylene glycol dibutyl ether, acetonitrile, propanenitrile, butanenitrile, N-methylpyrrolidone (NMP), dimethyl sulfoxide (DMSO), dimethylacetimide (DMAc), dimethylformamide (DMF), and tetrahydrofuran (THF). Suitable polymer binders for such electrodes can include polytetrafluoroethylene (PTFE) polyvinylidene fluoride (PVdF), carboxymethyl cellulose (CMC), polyvinyl alcohol, starch, hydroxypropyl cellulose, regenerated cellulose, polyvinylpyrrolidone, polyimide, polyamideimide, polyethylene, polypropylene, an ethylene-propylene-diene terpolymer (EPDM), a sulfonated EPDM, a styrene-butadiene rubber (SBR), a fluorine rubber, and a combination thereof. The solid substrate of the sulfur-containing electrode can be made from aluminum or stainless steel.

The sulfur-containing electrode can have an average sulfur/carbon composite mass of about 0.3 mg/cm⁻² to 2 mg/cm⁻². In some aspects, the sulfur/carbon composite in the sulfur-containing electrode is prepared by a melt-diffusion method including: (i) mixing sulfur and Ketjen Black (KB) in a weight ratio of about 1:2 to 2:1 to form a mixture; (ii) compressing the mixture into a pellet; and (iii) heating the pellet at about 125° C. to about 180° C. for about 8 hours to 20 hours under a vacuum atmosphere. The sulfur/carbon composite in the sulfur-containing electrode can have a sulfur:carbon mass ratio of about 1:2 to about 2:1.

Methods of making and methods of using the batteries and electrodes are also provided, e.g. for energy storage.

Other systems, methods, features, and advantages of the batteries and methods of use thereof will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIGS. 1A and 1B include the comparison of the reaction (FIG. 1A) Gibbs free energy and (FIG. 1B) cell voltage among the Li—O₂—S, Na—O₂—S and K—O₂—S systems.

FIG. 2 include the schematic drawings of (panel a) Na/S system, (panel b) Conventional Na/(C)—O₂ system using porous carbon cathode, (panel c) Na/(S)—O₂ system introducing O₂ gas through a porous sulfur-based cathode and (panel d) Na/(O₂)—S system introducing solvated O₂ in the electrolyte to promote the oxygen reactions in the solution phase.

FIGS. 3A-3F include (FIG. 3A) the voltage profiles of Na/S cell for the 1st, 2nd and 10th cycle, (FIG. 3B) the voltage profiles of Na/(C)—O₂ cell for the 1st, 2nd, 5th and 10th cycle, (FIG. 3C) The capacity decay of Na/(S)—O₂ cell for the initial two cycles, (FIG. 3D) the voltage profiles of Na/(O₂)—S cell for the 1st, 5th and 10th cycle, (FIG. 3E) the comparison of the initial discharge/charge voltage profiles for Na/S, Na/(C)—O₂, Na/(S)—O₂ and Na/(O₂)—S cells, (FIG. 3F) the comparison of cycling performance for Na/S, Na/(C)—O₂, Na/(S)—O₂ and Na/(O₂)—S cells.

FIGS. 4A-4E. The voltage profiles of initial discharge process of the (FIG. 4A) Na/S, (FIG. 4B) Na/(O₂)—S, (FIG. 4C) Na/(C)—O₂ and (FIG. 4D) Na/(S)—O₂ cells. (FIG. 4E) Photo images comparing the sodium anodes in the cells after initial discharge with fresh sodium anode.

FIGS. 5A to 5D include (FIG. 5A) the voltage profile of Na/S H cell in the initial discharge process with the inset showing a digital photo of the H cell, (FIG. 5B) the electrolyte color change of Na/S H cell at the different stage of the initial discharge process, (FIG. 5C) the voltage profile of Na/S H cell in the initial discharge process. The inset shows a digital photo of the Na/(O₂)—S H cell with inset digital photo, (FIG. 5D) the electrolyte color change of Na/(O₂)—S H cell at the different stage of the initial discharge process.

FIG. 6 includes 6 h recording of the open-circuit potential of the Na/S H cell before measurement. The open-circuit potential recording before the electrochemical test indicates the OCV drop of Na/S H cell from ˜2.3 V to 1.8 V, which is mainly attributed to the self-discharge and equilibrium in the cell. In contrast, the OCV of the Na/(O₂)—S H cell stable at about ˜2.32 V. The different evolution process of the OCV before the measurement reveal the different electrochemical equilibrium in the two systems.

FIG. 7 includes 6 h recording of the open-circuit potential of the Na/(O₂)—S H cell before measurement.

FIGS. 8A to 8H include the morphology evolution of the cathodes before (upper) and after (lower) the 1st discharge in the (FIG. 8A) Na/S, (FIG. 8B) Na/(C)—O₂, (FIG. 8C) Na/(O₂)—S, and (FIG. 8D) Na/(S)—O₂ cells.

FIG. 9 includes XRD patterns of the cathodes of Na/S, Na/(O₂)—S, Na/(C)—O₂ and Na/(S)—O₂ batteries after 1st discharge.

FIG. 10 includes Raman spectra of the cathodes of Na/S, Na/(O₂)—S, Na/(C)—O₂ and Na/(S)—O₂ batteries after 1st discharge.

FIGS. 11A to 11C The high-resolution XPS spectra of (FIG. 11A) Na 1s, (FIG. 11B) O 1s and (FIG. 11C) S 2p of the cathodes in Na/S, Na/(O₂)—S, Na/(C)—O₂ and Na/(S)—O₂ batteries after the first discharge.

### DETAILED DESCRIPTION

In the search for low-cost, room-temperature battery systems with high energy density, the chemistry and reactions pathway between sodium, oxygen and sulfur provide an attractive platform to meet these challenges owing to their ultra-abundant reactants and high energy density. However, the development on room-temperature Na/S and Na/O₂ systems faces fast capacity decay and low reversible capacities. Synergistically promoting sodium, oxygen and sulfur reactions offers an opportunity to reach a more reversible system. A high-energy density Na/(O₂)—S battery is made by electrolyte oxygen and sulfur reactions. A high reversible capacity over 1500 mA h/g with very low overpotentials (˜250 mV) are obtained during the cycles. Electrochemical mechanism investigation reveals the suppression of polysulfide crossover and crystal growth of the reaction products that contributes to the improved performance, which address the shuttle effect of sulfur reactions involving in various metal-sulfur batteries. The effective organization of sodium, sulfur and oxygen chemistries offer a route towards a high energy density sodium-based battery with better reversibility.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

In some instances, units may be used herein that are non-metric or non-SI units. Such units may be, for instance, in U.S. Customary Measures, e.g., as set forth by the National Institute of Standards and Technology, Department of Commerce, United States of America in publications such as NIST HB 44, NIST HB 133, NIST SP 811, NIST SP 1038, NBS Miscellaneous Publication 214, and the like. The units in U.S. Customary Measures are understood to include equivalent dimensions in metric and other units (e.g., a dimension disclosed as “1 inch” is intended to mean an equivalent dimension of “2.5 cm”; a unit disclosed as “1 pcf” is intended to mean an equivalent dimension of 0.157 kN/m³; or a unit disclosed 100° F. is intended to mean an equivalent dimension of 37.8° C.; and the like) as understood by a person of ordinary skill in the art.

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Batteries and Methods of Making and Use Thereof

A variety of battery technologies are provided that overcome one or more of the aforementioned deficiencies. In some aspects, a battery is provided having a sulfur-containing cathode; a metal anode; and an electrolyte between the cathode and the anode, wherein the electrolyte is capable of solvating metal ions produced from the metal anode, polysulfide species produced from the sulfur-containing cathode, and dissolved oxygen species.

Methods of making and methods of using the batteries and electrodes are also provided, e.g. for energy storage. The methods can include operating within at least 90%, 95%, or more of the peak efficiency for more than 10, 20, 40, or more than 100 charge/discharge cycles. In some aspects, the batteries have an energy density at room temperature of about 10³-10⁴ Wh/kg. In some aspects, the batteries or cells demonstrate superior recycle performance. For examples, the battery cells can exhibit storage capacity retention of at least 60% over the first 10 charge/discharge cycles. The battery can have a reversible capacity of about 1300 mAh/g to about 1700 mAh/g. The battery can have an overpotential of about 200 mV to about 300 mV during cycles. The battery can have an energy density of about 450 Wh/kg to about 1000 Wh/kg.

During battery cycles the sulfur-containing electrode can a discharge product of metal sulfides, for example products of a formula of MₐSₙ where a is an integer from 1 to 3 and n is an integer from 2 to 5. M can be Na, K, or other suitable metal depending upon the choice of anode.

Sulfur-Containing Cathodes and Methods of Making Thereof

The batteries described herein can include a sulfur-containing cathode material. The sulfur-containing cathode can be prepared by any one of a number of methods. The sulfur can be deposited or impregnated into a metal. The sulfur-containing cathodes can include impregnating a metal surface and/or coating a metal surface with sulfur. The coating can include using a polymer binder. The sulfur-containing cathode can be porous so as to allow oxygen gas to enter the battery. The sulfur-containing cathode can also be non-porous to oxygen gas, e.g. where the electrolyte is saturated with oxygen prior to use and then replenished after use. Solvated oxygen can be introduced into the cathode region by injecting oxygen in the sulfur-containing cathode, saturating the electrolyte with oxygen gas, both, or by any other suitable approach. In some aspects, the solvated oxygen concentration is more than 10⁻⁵ mol/L, e.g. about 10⁻⁵ mol/L to about 10⁻⁴ mol/L, about 10⁻⁵ mol/L to about 10⁻³ mol/L, about 10⁻⁵ mol/L to about 10⁻² mol/L, or about 10⁻⁴ mol/L to about 10⁻² mol/L.

The sulfur-containing cathode can include a carbon electrode and/or a metal electrode impregnated with sulfur on an outer surface of the electrode. In some aspects, the sulfur-containing cathode is made by a process including casting a slurry onto a solid substrate to form a film, the slurry having sulfur, carbon, and a polymer binder in a suitable solvent; and then drying the film at an elevated temperature to form the sulfur-containing cathode. In some aspects, the slurry has a sulfur/carbon composite and binder solution mass ratio of about 1:1 to about 3:1. In some aspects, the solvent is selected from the group consisting of diethylene glycol dimethyl ether, triethylene glycol dimethyl ether, tetraethylene glycol dimethyl ether, diethylene glycol diethyl ether, diethylene glycol dibutyl ether, acetonitrile, propanenitrile, butanenitrile, N-methylpyrrolidone (NM P), dimethyl sulfoxide (DMSO), dimethylacetimide (DMAc), dimethylformamide (DMF), and tetrahydrofuran (THF). Suitable polymer binders for such electrodes can include polytetrafluoroethylene (PTFE) polyvinylidene fluoride (PVdF), carboxymethyl cellulose (CMC), polyvinyl alcohol, starch, hydroxypropyl cellulose, regenerated cellulose, polyvinylpyrrolidone, polyimide, polyamideimide, polyethylene, polypropylene, an ethylene-propylene-diene terpolymer (EPDM), a sulfonated EPDM, a styrene-butadiene rubber (SBR), a fluorine rubber, and a combination thereof. The solid substrate of the sulfur-containing electrode can be made from aluminum or stainless steel.

The sulfur-containing electrode can have an average sulfur/carbon composite mass of about 0.3 mg/cm⁻² to 2 mg/cm⁻². In some aspects, the sulfur/carbon composite in the sulfur-containing electrode is prepared by a melt-diffusion method including: (i) mixing sulfur and Ketjen Black (KB) in a weight ratio of about 1:2 to 2:1 to form a mixture; (ii) compressing the mixture into a pellet; and (iii) heating the pellet at about 125° C. to about 180° C. for about 8 hours to 20 hours under a vacuum atmosphere. The sulfur/carbon composite in the sulfur-containing electrode can have a sulfur:carbon mass ratio of about 1:2 to about 2:1.

Metal Anodes

A variety of metal anodes can be utilized in the batteries descried herein as long as they are compatible with the electrolyte chosen. The metal anode can include sodium and/or potassium. The anode can include a metal alloy anode including the sodium and/or potassium, e.g. alloy anodes made of antimony (Sb), tin (Sn), phosphorus (P), germanium (Ge) and lead (Pb) have been envisioned. Carbon anodes provide organic complexes for the storage of Na⁺ or K⁺ ions, while alloyed anodes form inorganic complexes with the Na⁺ or K⁺ ions, such as Na₃Sb, Na₃Sn and Na₃P.

Electrolytes

The battery will include a suitable electrolyte. The electrolyte can include a solid electrolyte material dissolved in a solvent. The solid electrolyte material can be selected from the group consisting of sodium triflate and potassium triflate. The solvent of the liquid electrolyte can be selected from the group consisting of diethylene glycol dimethyl ether, triethylene glycol dimethyl ether, tetraethylene glycol dimethyl ether, diethylene glycol diethyl ether, diethylene glycol dibutyl ether, acetonitrile, propanenitrile, butanenitrile, dimethyl sulfoxide (DMSO), dimethylformamide (DMF), and tetrahydrofuran (THF), propylene carbonate. The solid electrolyte material can be present at a concentration of about 0.1 M to about 1.0 M based upon a volume of the liquid electrolyte. The electrolyte can be capable of solvating the polysulfide species. For examples, the polysulfide can be present in the electrolyte at a concentration of about 0.1 mol/L to about 62.5 mol/L.

Separators

In some aspects, the battery includes a separator separating the battery into a cathode region nearest the cathode and an anode region nearest the anode, wherein the separator permits permeability of the electrolyte and the metal ions. The separator can be moistened with electrolyte and forms a catalyst that promotes the movement of ions from cathode to anode on charge and in reverse on discharge. In some aspects, the battery does not need a separator since the reactions can in some instances completely eliminate sulfur crossover, which can provide for cost savings. The separators can include a variety of membranes as are known in the industry. The separator can include a polymer membrane and/or a glass fiber mat. The separator can include one or more materials selected from the group consisting of nonwoven fibers, polyolefin, poly(tetrafluoroethylene), polyvinyl chloride, cellulose, ceramic, and a combination thereof.

### Examples

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

Energy Density Projection of Hybrid Na/(O₂)—S System

The Na/(O₂)—S battery demonstrates greater cycling performance than Na/S or Na/O₂ battery alone due to the suppression of polysulfide crossover and crystal growth of the reaction products. An approach to overcome the issues of Na/S and Na/O₂ systems is to utilize both solvated oxygen and sulfur as the integrated cathode of a Na/(O₂)—S battery system. Table 1 shows the thermodynamic calculations, capacity and energy density of possible reaction products in RT Na/S and Na/O₂ systems.

TABLE 1
The thermodynamic calculations, capacity and energy density of possible reactions
in RT-Na/S and RT-Na/O₂ system. Only batteries with Na₂Sₙ (n = 2~5) and
NaO₂ as discharge products report good electrochemical reversibility.

| | | | | | Spec. | Spec. |
|---|---|---|---|---|---|---|
| Discharge | | Δ_{γ}G/ | E°/ | | Capacity/ | Energy/ |
| products | Reactions | kJ mol⁻¹ | V | z | mAh · g⁻¹ | Wh · kg⁻¹ |
| Na₂S | 2Na + S → Na₂S | −349.80 | 1.81 | 2 | 687.22 (Na₂S) | 1245.73 |
| | | | | | 1675.09 (S) | |
| Na₂S₂ | 2Na + 2S → | −392.00 | 2.03 | 2 | 487.30 (Na₂S₂) | 989.90 |
| | Na₂S₂ | | | | 837.54 (S) | |
| Na₂Sₙ | 2Na + nS → | ≈−366.64 | 1.78~2.08 | 2 | 260.21~377.48 | 494.40~717.21 |
| (n = 3~5) | Na₂Sₙ | | | | (Na₂Sn) | |
| | (n = 3~5) | | | | 335.02-558.36 (S) | |
| Na₂O₂ | 2Na + O₂ → | −449.72 | 2.33 | 2 | 689.00 | 1605.37 |
| | Na₂O₂ | | | | (Na₂O₂) | |
| NaO₂ | Na + O₂ → | −218.76 | 2.27 | 1 | 488.21 (NaO₂) | 1108.22 |
| | NaO₂ | | | | | |

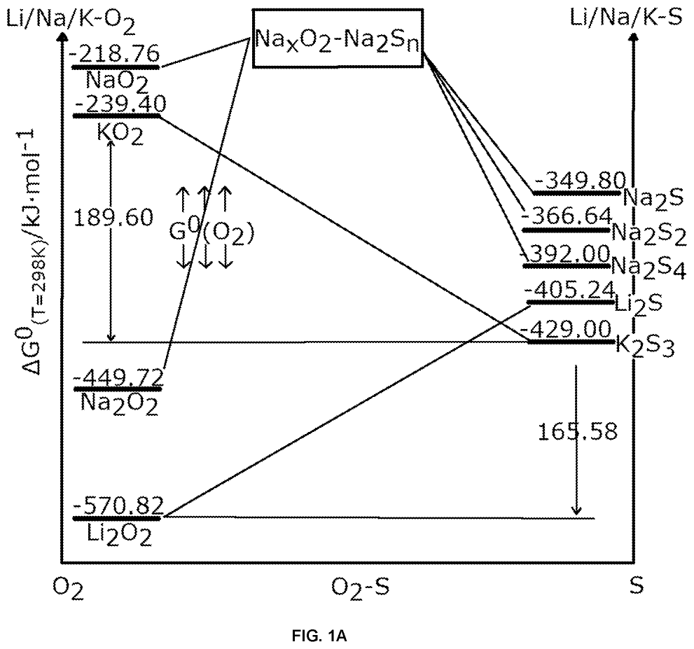

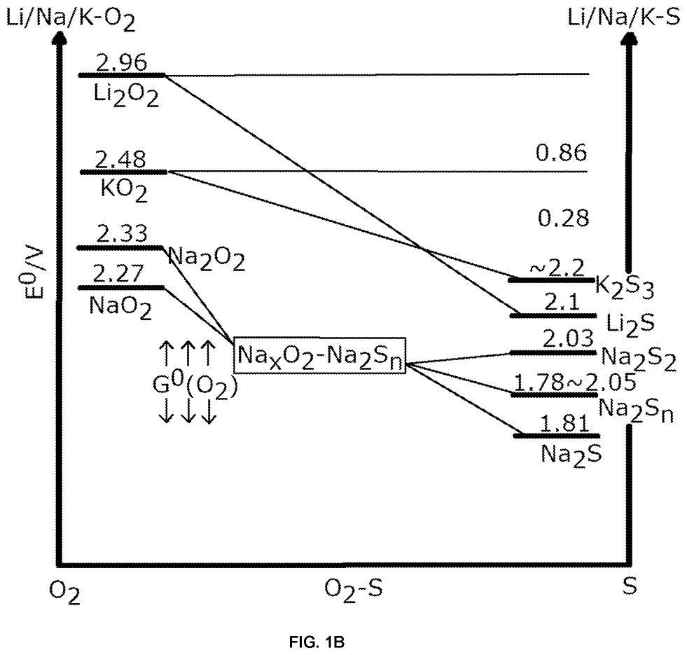

Various sodium polysulfide species have been reported in the RT-Na/S system and the theoretical voltage plateau on these reactions is found to be located around 2.0 V. Based on the aforementioned studies of RT Na/S batteries, the practical voltage range is between the 2.2 V (S₆) and 1.6 V (Na₂S₂). Since the theoretical voltage plateaus of both the NaO₂ and Na₂O₂ are found to be around 2.3 V with the reported practical voltage plateau around 2.2 V, the voltage profiles of the Na/S and Na/O₂ systems should have an overlapping region. By comparison, the differences of Gibbs free energy and voltage plateau between Na/O₂ and Na/S systems are smaller than those in the Li and K-based systems (FIGS. 1A and 1B). In addition, the practical charging process of Na/O₂ battery based on NaO₂ discharge product shows a stable plateau around 2.3 V with low overpotential, which has a voltage intersection with the charging voltage profile of Na/S system. Such chemical interactions offer the possible synergies of a hybrid Na/(O₂)—S system that projects higher energy density than that of Na/S system (highest practically achievable energy density of 990 Wh/kg with Na₂Sₙ, n=2-5 as the discharging product) by involving oxygen reactions.

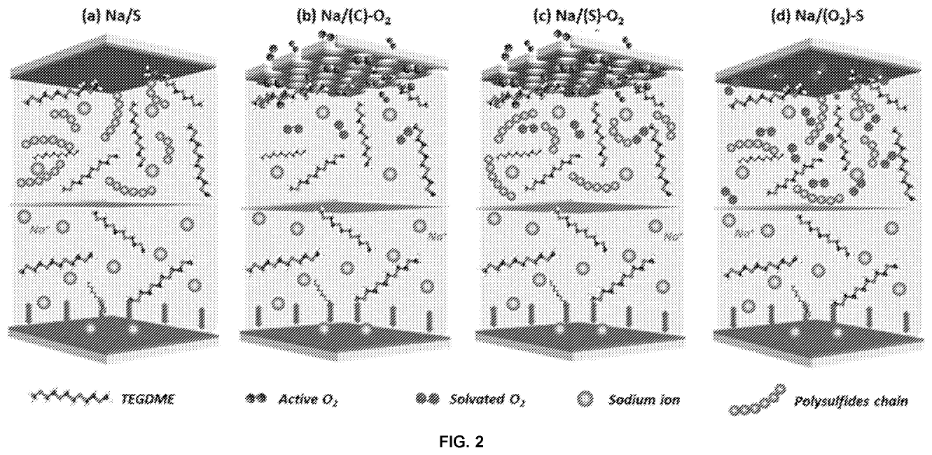

To design such a system based on the hybrid interactions between Na/S (FIG. 2, panel a) and Na/O₂ (FIG. 2, panel b), oxygen can be either directly introduced through a porous sulfur-based cathode (FIG. 2, panel c) or through solvated O₂ in the electrolyte (FIG. 2, panel d). Since the solution phase reaction mechanism applies to both Na/O₂ and Na/S systems, the liquid electrolyte provides a media for the complex reactions among the Na-ion, polysulfides and solvated O₂ species. Na/(C)—O₂ is used to represent the conventional Na/O₂ system to distinguish it from Na/(S)—O₂ system. FIG. 2, panel d shows the proposed electrolyte reaction scheme among sodium, sulfur and oxygen in the electrolyte of Na/(O₂)—S system. Unlike the air-exposing porous cathode in Na/(C)—O₂ and Na/(S)—O₂ systems, the Na/(O₂)—S cell electrode is made of S/C composite coating on the Al foil (similar to RT-Na/S electrode) and the S/C composite cathode is soaked in electrolyte without direct contact with gaseous oxygen. By incorporating the solvated oxygen in the electrolyte and sulfur-based cathode, the Na/(O₂)—S system shows higher capacity and energy density than Na/S system and better cycling performance than Na/(C)—O₂ and Na/(S)—O₂ systems.

Preparation of the Cathode

The sulfur/carbon (S/C) composite was prepared following a melt-diffusion strategy through mixing sulfur and Ketjen Black (KB) in the weight ratio of 3:2. Then the composite was compressed in a pellet (˜0.3 g samples, ϕ=12.7 mm, thickness≈8 mm) and heated in an oven at 155° C. for 12 h under vacuum. The mass percentage is found to be 60 wt % S/40 wt % C verified by TGA analysis. The slurry was prepared by milling 70 wt % S/C composite and 30 wt % polyvinylidene difluoride (PVDF) in N-Methylpyrrolidone (NMP). For the cathode used in Na/S and Na/(O₂)—S cell, the uniform slurry was casted onto an aluminum foil substrate. The cathode for Na/(S)—O₂ battery was prepared by coating the slurry on stainless steel mesh. All the cathodes were dried at 60° C. under vacuum for 12 h. The average active material area mass is about 1.0 mg cm⁻². The porous carbon cathode for Na/O₂ cell is prepared by coating carbon/PTFE (9:1 in mass ratio) slurry on stainless steel mesh with an average mass loading of 0.5 mg cm⁻².

Cell Assembly and Electrochemical Experiments

Electrochemical experiments were performed using CR2032-type coin cell, consisting sodium metal foil as the anode, glass microfiber filters (GF/D, Whatman) as separator and the cathode described in the cathode preparation part. 0.5 M sodium triflate (NaSO₃CF₃, 98%, Aldrich)/tetraethylene glycol dimethyl ether (TEGDME, 99%, Alfa Aesar) was used as the electrolyte. NaSO₃CF₃ was dried under vacuum at 110° C. for 24 h and TEGDME was dried by 3 Å molecular sieves for over 3 weeks. In comparison, 1M sodium perchlorate (NaClO₄)/Propylene carbonate (PC) were prepared by the same method. (This sentence is probably not needed) Each cell contained 100 μL of electrolyte. Assembly and sealing of Na/S coin cell were conducted in an argon-filled glovebox (O₂<0.1 ppm, H₂O<0.1 ppm). The Na/(S)—O₂ and Na/(C)—O₂ cells were assembled in the CR2032-type coin cells with holes for O₂ access and then put into a glass chamber with complete gas tightness and gas valves for the entrance and exit of oxygen. Before measurements, the cells were flushed with oxygen for 30 min. For Na/(O₂)—S cell, the electrolyte was firstly flushed with oxygen for 1 h and subsequently, the coin cell was assembled in the oxygen-filled box. All cells were cycled galvanostatically (constant current) on a LAND battery tester at room temperature. The current density and specific capacity in Na/S, Na/(O₂)—S and Na/(S)—O₂ cells are calculated by the mass of sulfur in the cathode. For Na/O₂ battery, the current density and specific capacity are calculated by the carbon mass in the porous cathode.

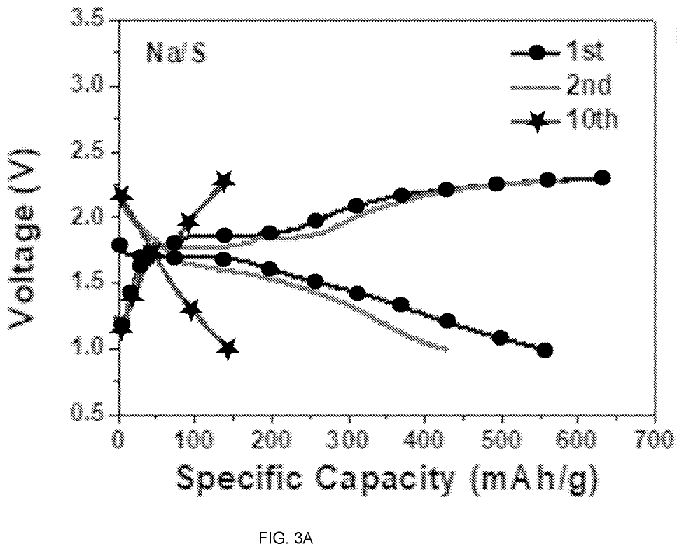

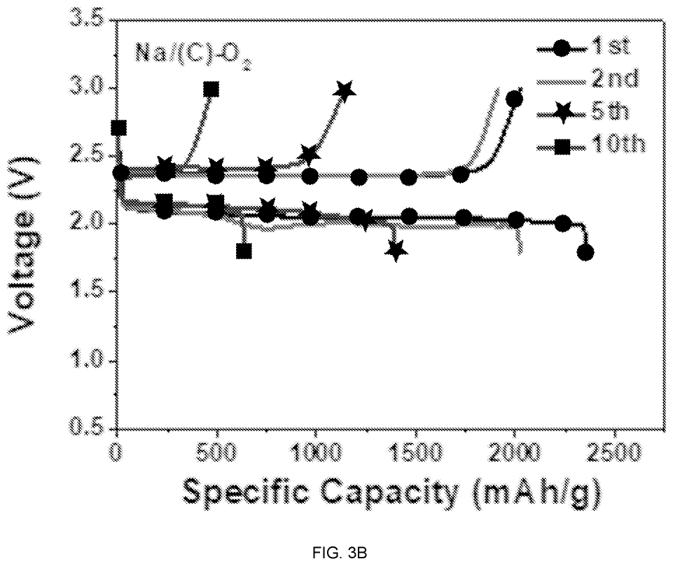

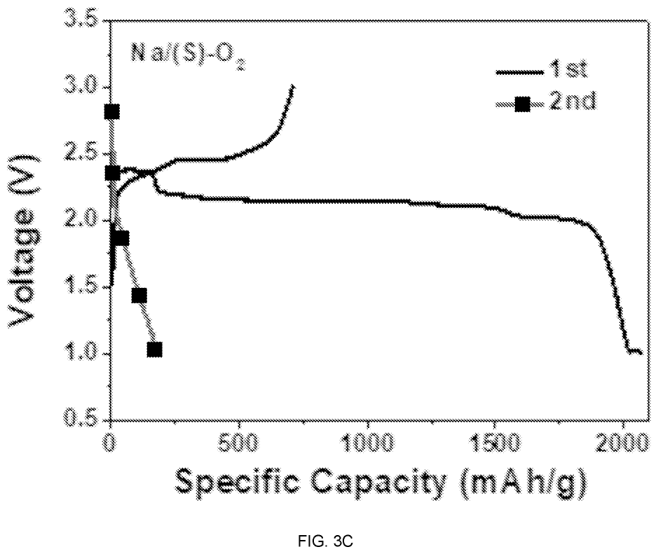

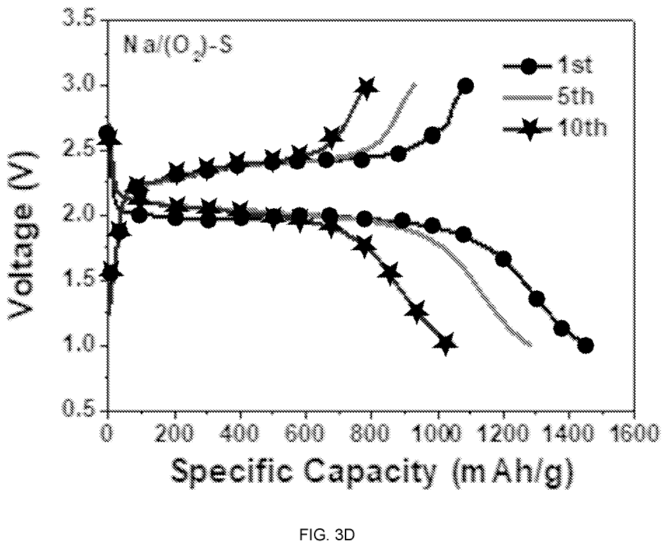

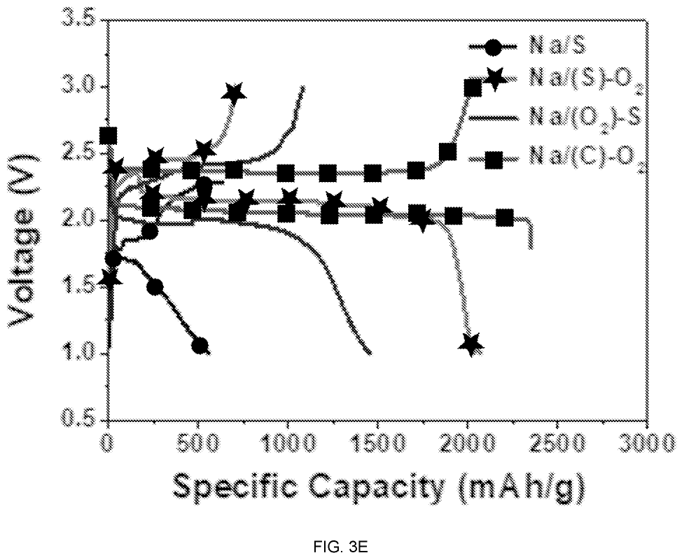

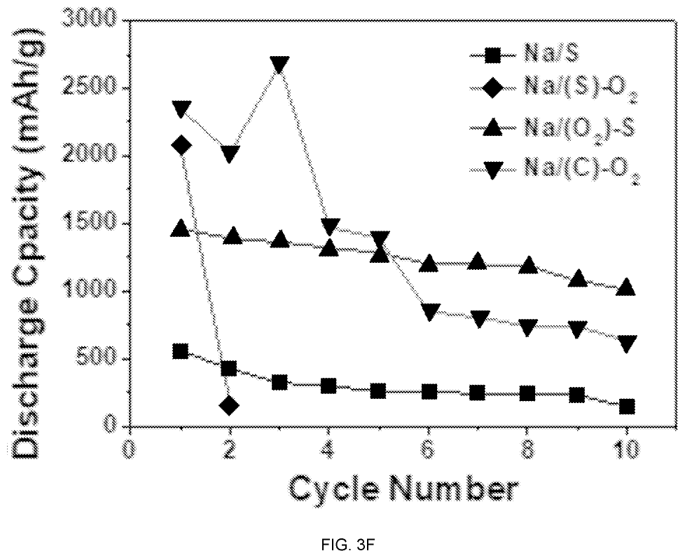

FIG. 3 summarizes the comparative study of the electrochemical performance of Na/S, Na/(S)—O₂, Na/(C)—O₂ and Na/(O₂)—S cells. The four types of cells were constructed by using sodium metal anode, Whatman GF/D glassfiber separator and 0.5 M NaCF₃SO₃/Tetraglyme (TEGDME) electrolyte. The specific capacities of Na/S, Na/(S)—O₂ and Na/(O₂)—S cells are calculated using the mass of S in the cathode while the Na/(C)—O₂ cell uses the mass of C in the cathode. Due to the polysulfide dissolution in the TEGDME electrolyte and inadequate sulfur utilization, the Na/S cell only delivers a low initial discharge capacity of 594 mA h/g and experiences rapid capacity fading (FIG. 3A). Although Na/(C)—O₂ and Na/(S)—O₂ cells display higher initial discharge capacities than that of Na/(O₂)—S cell attributable to the formation of oxides, both of them show severe capacity decay after several cycles and Na/(S)—O₂ is not rechargeable after the 2^{nd} cycle (FIGS. 3B and 3C). In contrast, the Na/(O₂)—S cell delivers a high discharge capacity of 1457 mA h/g with a capacity retention of 1071 mA h/g even after 10 cycles (FIG. 3D), demonstrating more stable cycling performance than all other three battery systems. FIG. 3E shows the comparison of initial discharge/charge voltage profiles for Na/S, Na/(C)—O₂, Na/(S)—O₂ and Na/(O₂)—S cells. Notably, the open-circuit voltage of Na/(O₂)—S is found to be around 2.56 V, which is higher than the Na/S cell (˜1.85 V) and close to that of Na/(S)O₂ batteries (˜2.60 V). The discharge voltage plateau of Na/(C)—O₂ is located at around 2.1 V, which agrees well with the previous report. Although the columbic efficiency of the Na/(O₂)—S system without optimization can only reach about 75% during the cycle, the cycling performance with a high reversible capacity is greatly improved comparing to Na/(C)—O₂ and Na/S system (FIG. 3F). The Na/(O₂)—S cell with PC-based electrolyte also show increased capacity around the discharge plateau around 2.1 V, while separate reaction plateaus and fast capacity decay occur in this system. The direct comparison indicates the TEGDME electrolyte with polysulfides solubility enable the synergistically incorporation of electrolyte oxygen and sulfur reactions. In contrast, similar discharge and charge profile is present between Li/(O₂)—S and Li/S system, which further verifies the electrolyte solvation mechanism between sodium, sulfur and oxygen.

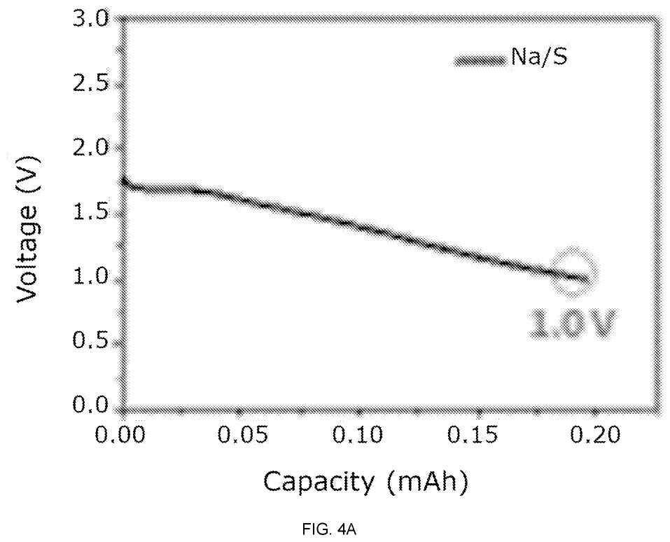

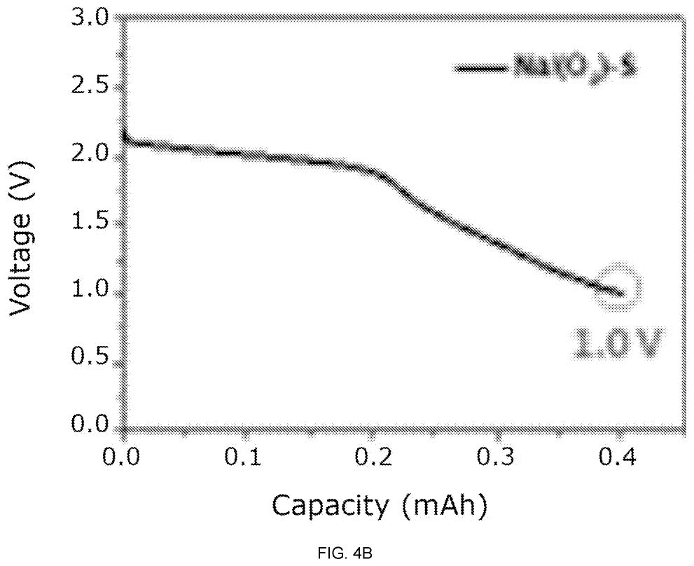

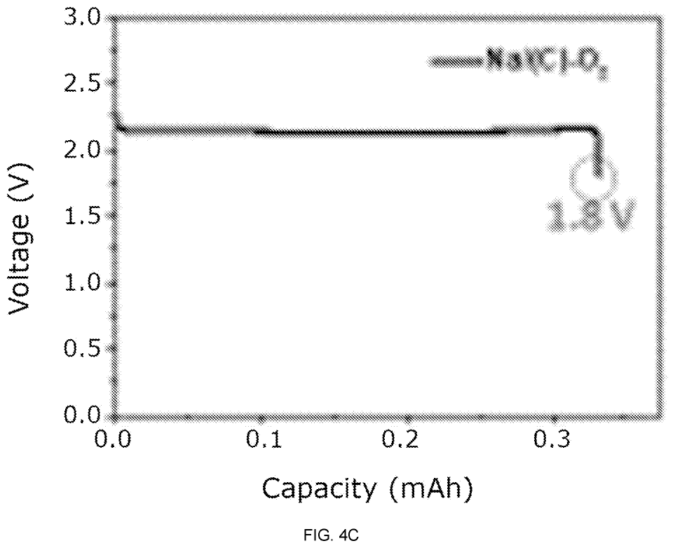

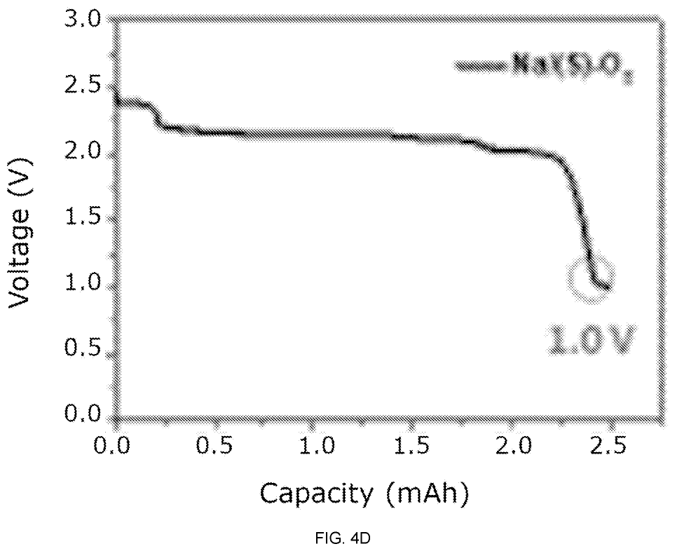

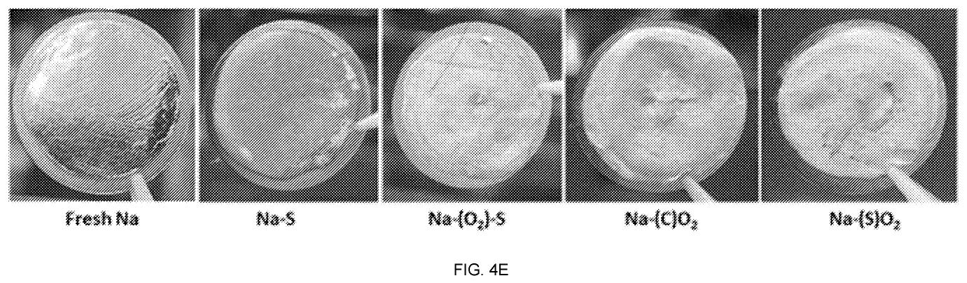

In order to understand the improved electrochemical performance of Na/(O₂)—S, the cycled Na/S, Na/(C)—O₂, Na/(S)—O₂ and Na/(O₂)—S cells were disassembled to investigate the sodium metal anodes and their cathodes at discharged state. Due to the high solubility of high-order polysulfides (Sₙ²⁻, 4<n≤8) in the TEGDME electrolyte and their distinguishable yellow color, it is identified as the polysulfide shuttling effect during the discharge process by directly observing the sodium metal anode surface. FIGS. 4A-4D show the voltage profiles of initial discharge of the Na/S, Na/(O₂)—S, Na/(C)—O₂ and Na/(S)—O₂ cells. The cells were disassembled when reaching the cutoff voltages labeled in the figures. Compared to the fresh Na anode, the anode surface of the Na/S cell shows bright yellow color after discharging to 1.0 V, indicating that the polysulfides dissolved in the electrolyte and deposited on the surface of the anode (FIGS. 4A and 4E). The Na anode in the sulfur-free Na/(C)—O₂ batteries shows SEI formation with no color change (FIGS. 4C and 4E). In the Na/(O₂)—S and Na/(S)—O₂ cells, both Na anodes surprisingly show similar color change to the Na anode in the sulfur-free Na/(C)—O₂ system even with the participation of sulfur redox reaction process (both cells were discharged to 1.0V), indicating the alleviation of polysulfide shuttling effect in these two systems. The discharge voltage profiles and the sodium anode surface changes suggest reactions among the Na⁺, O₂⁻ and Sₙ²⁻ (4<n≤8) at the early stage of discharge reaction in the Na/(O₂)—S and Na/(S)—O₂ systems that prevent the polysulfides from diffusing or migrating to the anode side.

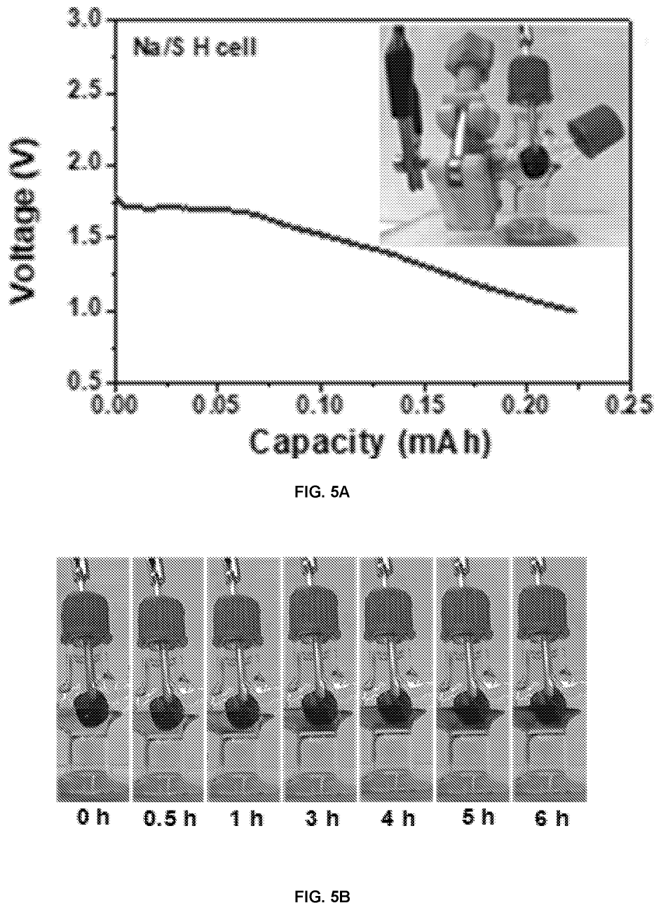

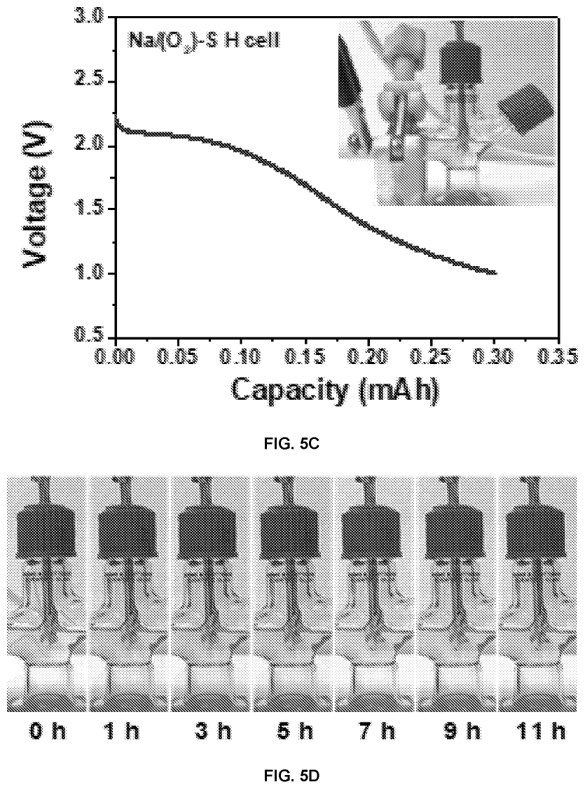

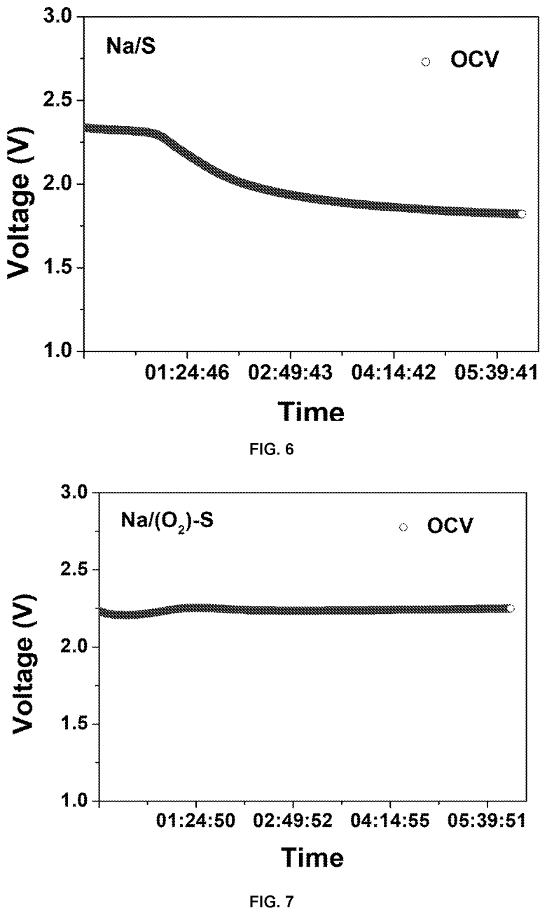

To detect the dissolve of polysulfides in the solution and probe the reactions pathway of the Na/(O₂)—S system, Na/S and Na/(O₂)—S, H cells were constructed to display the color change of electrolyte during discharge process (inset pictures in FIGS. 5A and 5C). Comparing to the coin cell structure, the Na/S and Na/(O₂)—S H cells demonstrate similar discharge and charge profiles. For the pure Na—S system, the color of the electrolyte appears to be light blue and the open-circuit potential is located at ˜1.8 V, which is mainly attributed to the self-discharge and equilibrium in the cell (FIG. 6). When discharging the Na/S H cell, the brown species start release into the electrolyte and tend to be more severe at the whole discharge process (FIG. 5B). In contrast, OCV of the Na/(O₂)—S H cell stables at about −2.32 V and color of the TEGDME electrolyte keeps transparent (FIG. 7). The recorded digital images of the electrolyte reveal trace amount of brown Na₂S₈ species in the transparent TEGDME at the middle stage of the discharge process and stable without further increase after 11 hours discharge process (FIG. 5D). SEM reveals the formation of sulfur-rich species on the surface of Na anode from Na/S H cell, while only trace amount of sulfur was present on the anode from Na/(O₂)—S H cell. Considering the sulfur element involved conductive salts in the electrolyte, the shuttle effect of polysulfides in Na/(O₂)—S could be neglected. The electrolyte color change in the two systems also verify the results in FIG. 4E, indicating the different reaction mechanism and pathway in the Na/(O₂)—S system from traditional alkali metal-sulfur batteries.

Scanning Electron Microscopy

Scanning electron microscopy (SEM) investigations were performed on a FEI Quanta 600 FEG environmental scanning electron microscope. Structural characterization of the discharge products was carried out using a Bruker D2 Phaser Table-top Diffractometer using Cu-Kα radiation at 30 kV and 10 mA, with a scan rate of 0.1° (2θ)/s between 15 and 80°.

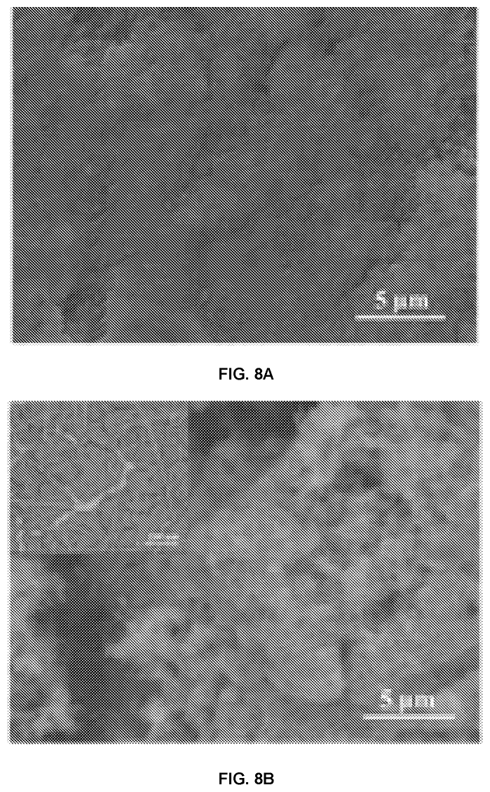

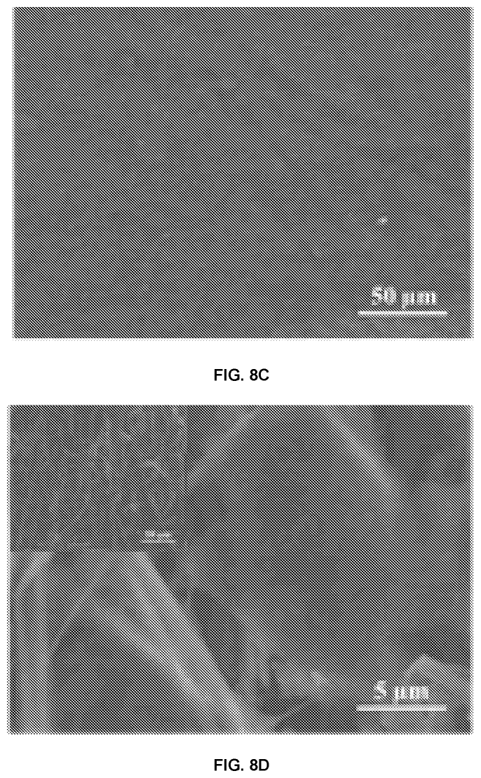

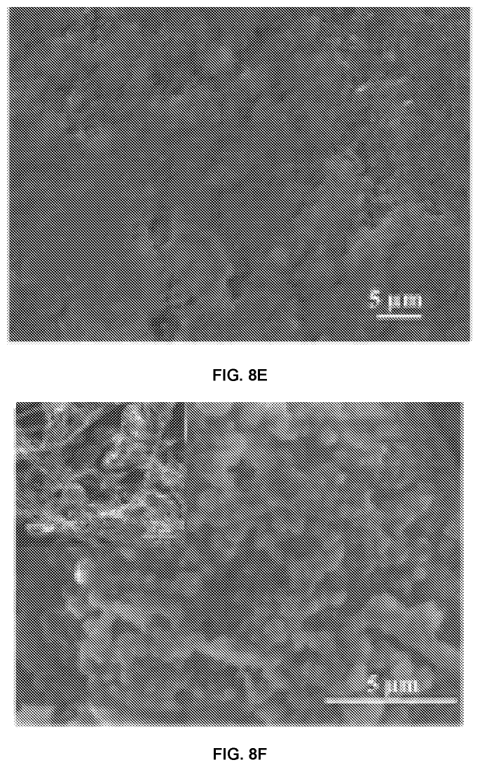

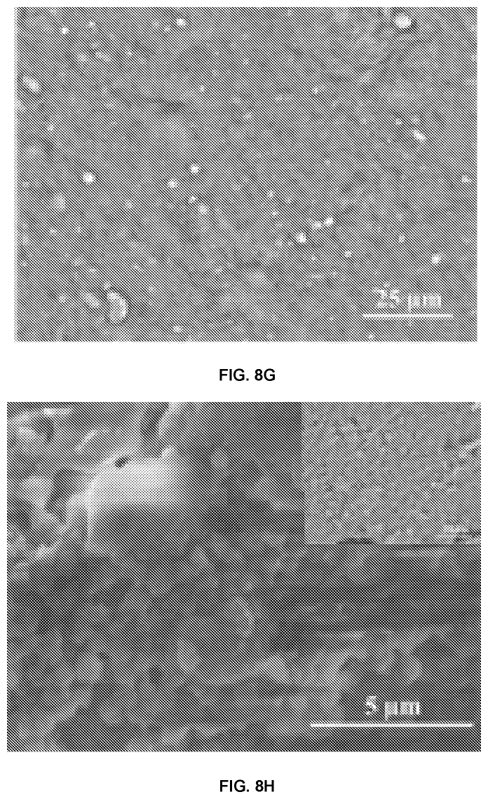

In the Na/S cell, SEM images show cracked electrode and agglomerated small particles in the fully-discharged sulfur cathode (FIGS. 8A and 8B), which is attributable to the dissolution of polysulfides in the TEGDME-based electrolyte. Due to the unique cubic structure of NaO₂ formed in the Na/O₂ cell, SEM can effectively distinguish the NaO₂ cubes from other discharge products. The results confirm the formation of cubic NaO₂ discharge products in the Na/O₂ cell (FIGS. 8C and 8D). In contrast, the discharged cathode of Na/(O₂)—S cell is composed of uniformly deposited ultrafine nanoparticles (FIGS. 8E and 8F). This reduced particle size is possibly the main reason for a better reversibility during the charging process. Both large cubic particles and nanoparticle agglomerates are present in the discharged cathode of the Na/(S)—O₂ system (FIGS. 8G and 8H). In the Na/(S)—O₂ system, the O₂ can diffuse through the porous cathode and present in both gas form in the porous cathode and solvated form in liquid electrolyte. The solvated O₂ in electrolyte can lead to the formation of similar discharge products seen in the Na/(O₂)—S system while the reaction between O₂ in gas phase and Na-ion form cubic NaO₂ on the porous S/C cathode.

X-Ray Diffraction

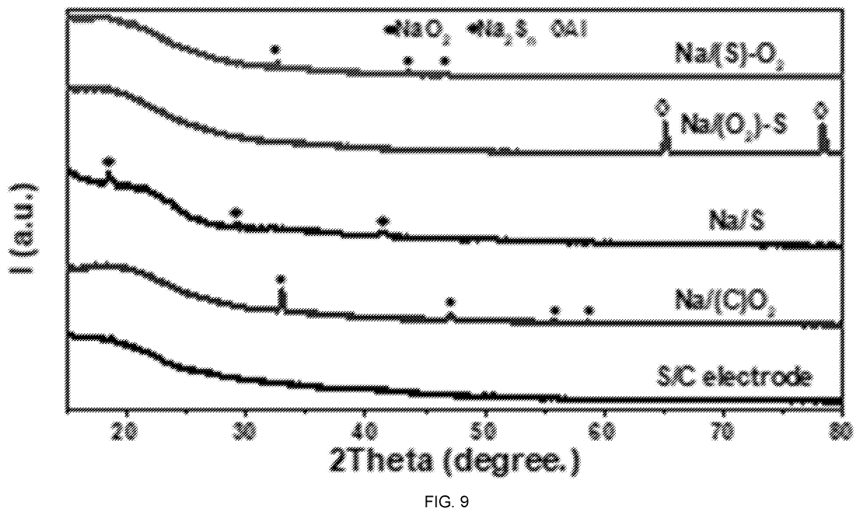

X-ray diffraction (XRD) analysis allows a direct investigation of the crystal information of the discharge products. First, the S/C composite (60 wt % S-40 wt % C) cathode material used in these batteries was characterized before discharging. The S/C composite was prepared by impregnating sulfur into the porous Ketjen Black. The disappearance of XRD diffraction peaks of sulfur confirms the successful impregnation of sulfur in the carbon matrix. In the Na/(C)—O₂ cell, the XRD results show the formation of NaO₂ on the cathode side. For the Na/S system, three peaks appeared at 18.38°, 29.15° and 42.5°, which were possibly originated from the final discharge product of sodium polysulfides (FIG. 9). There are no diffraction peaks for the discharged cathode of the Na/(O₂)—S cell, indicating the non-crystalline nature of the discharge products. In contrast, NaO₂ is identified as the discharge product in the Na/(S)—O₂ cell. Both the positions of the diffraction lines and the intensities agree with JCPDS reference card No. 01-077-0207. This happens because the O₂ is directly introduced through the porous cathode material in the Na/(S)—O₂ system and the O₂ partial pressure is much higher than that in the Na/(O₂)—S system where only the solvated O₂ in the electrolyte participate in the reaction. The non-crystalline nature of the discharge products in Na/(O₂)—S cell is attributed to the formation of chemical bonding between NaO₂ and Na₂Sₙ during nucleation process that hinders the particle growth into well-crystallized NaO₂ or Na₂Sₙ single-phase discharge product.

### Raman Spectroscopy

Raman spectroscopy was collected by a HR800 Raman microprobe with a 514 nm laser excitation. A sample holder was used to keep the discharged cathode from exposing to air.

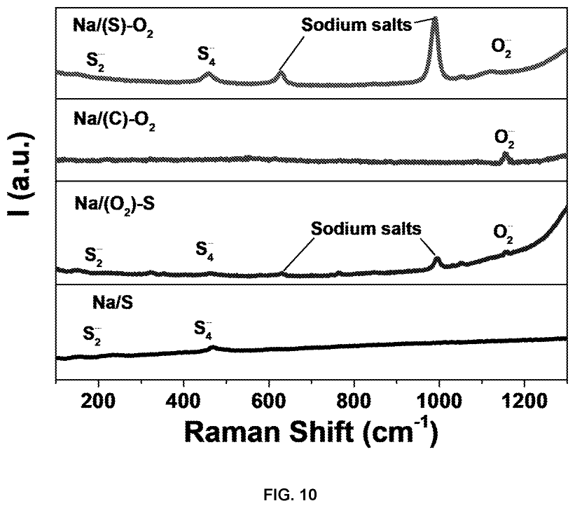

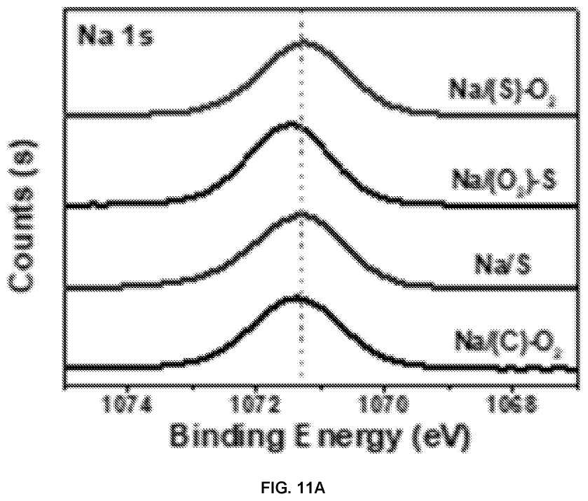

Raman spectroscopy is used to study superoxide and polysulfide speciation and their structures, especially when they are in solution phase or in non-crystalline solid phase. The Raman spectrum of the discharged cathode of Na/(O₂)—S battery is shown in FIG. 10 and compared with those of Na/S, Na/(C)—O₂ and Na/(S)—O₂ batteries. The appearance of the intense Raman band at 1,156 cm⁻¹ proves that NaO₂ is the discharge product in Na/(C)—O₂ cell. In the Na—S cell, Raman bands at 134 and 482 cm⁻¹ are related to Na₂S₂ and Na₂S₄, respectively. Moreover, the vibration peaks of O₂⁻, S₂²⁻, and S₄²⁻ species in the Na/(O₂)—S and Na/(S)—O₂ systems were also present, indicating the reactions among Na⁺, O₂ and S in these two hybrid systems. Combined with the preliminary SEM and XRD results, the ex-situ Raman results further confirm that the non-crystalline cluster deposited on the cathode surface of Na/(O₂)—S system is composed of ultrafine NaO₂, Na₂S₂ and Na₂S₄ particles.

X-Ray Photoelectron Spectroscopy

XPS characterization was performed on a PHI Versa Probe III scanning XPS microscope using monochromatic Al K-alpha X-ray source (1486.6 eV). XPS Spectra were acquired with 200 μm/50 W/15 kV X-ray settings and dual beam charge neutralization. All binding energies were referenced to K 2p3/2 peak at 292.8 eV.

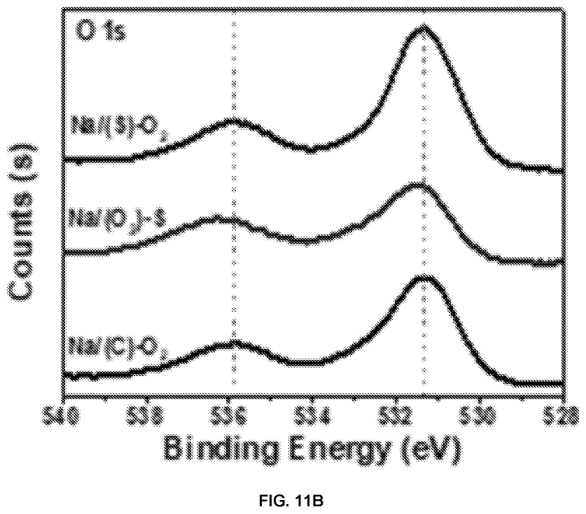

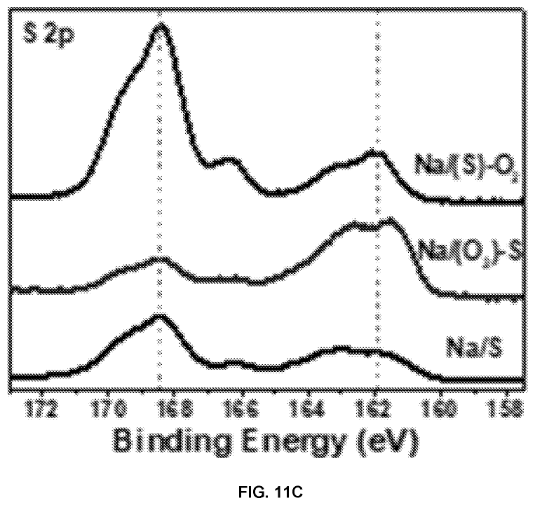

FIGS. 11A-C shows the Na1s, O1s and S2p spectral lines of the discharged cathode in the Na/S, Na/(O₂)—S, Na/(C)—O₂ and Na/(S)—O₂ systems. The Na1s (FIG. 11A) and O1s (FIG. 11B) XPS spectra of the Na/(O₂)—S cell show a shift to a higher binding energy, while S2p shifts to a lower binding energy (FIG. 11C). This direct comparison indicates the change of the chemical state of the main discharge products, which is associated with the chemical bonding among ultrafine NaO₂, Na₂S₂ and Na₂S₄ particles.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. (canceled)

2. A battery comprising:
(i) a sulfur-containing cathode;
(ii) a metal anode;
(iii) an electrolyte between the cathode and the anode, wherein the electrolyte is capable of solvating metal ions produced from the metal anode, polysulfide species produced from the sulfur-containing cathode, and dissolved oxygen species; and
(iv) a separator separating the battery into a cathode region nearest the cathode and an anode region nearest the anode, wherein the separator permits permeability of the electrolyte and the metal ions.

3. The battery according to claim 2, wherein the sulfur-containing cathode is porous to allow oxygen gas to enter the battery.

4. The battery according to claim 2, wherein the sulfur-containing cathode is non-porous to oxygen gas.

5. (canceled)

6. The battery according to claim 2, wherein the solvated oxygen concentration is more than 10⁻⁵ mol/L.

7. (canceled)

8. The battery according to claim 2, wherein during battery cycles the sulfur-containing electrode produces a discharge polysulfide with a formula of Na₂Sₙ wherein n is an integer from 2 to 5;
wherein the polysulfide is present in the electrolyte at a concentration of about 0.1 mol/L to about 62.5 mol/L.

9. (canceled)

10. The battery according to claim 2, wherein the sulfur-containing cathode comprises a carbon electrode impregnated with sulfur on an outer surface of the carbon electrode;
wherein the sulfur-containing cathode is made by a process comprising casting a slurry onto a solid substrate to form a film, the slurry comprising sulfur, carbon, and a polymer binder in a suitable solvent;
drying the film at an elevated temperature to form the sulfur-containing cathode.

11. The battery according to claim 10, wherein the slurry comprises a sulfur/carbon composite and binder solution mass ratio of about 1:1 to about 3:1.

12. The battery according to claim 10, wherein the suitable solvent is selected from the group consisting of diethylene glycol dimethyl ether, triethylene glycol dimethyl ether, tetraethylene glycol dimethyl ether, diethylene glycol diethyl ether, diethylene glycol dibutyl ether, acetonitrile, propanenitrile, butanenitrile, N-methylpyrrolidone (NMP), dimethyl sulfoxide (DMSO), dimethylacetimide (DMAc), dimethylformamide (DMF), and tetrahydrofuran (THF).

13. The battery according to claim 10, wherein the polymer binder is selected from the group consisting of Polytetrafluoroethylene (PTFE) polyvinylidene fluoride (PVdF), carboxymethyl cellulose (CMC), polyvinyl alcohol, starch, hydroxypropyl cellulose, regenerated cellulose, polyvinylpyrrolidone, polyimide, polyamideimide, polyethylene, polypropylene, an ethylene-propylene-diene terpolymer (EPDM), a sulfonated EPDM, a styrene-butadiene rubber (SBR), a fluorine rubber, and a combination thereof.

14. (canceled)

15. (canceled)

16. The battery according to claim 10, wherein the sulfur-containing electrode has an average sulfur/carbon composite mass of about 0.3 mg/cm⁻² to 2 mg/cm⁻².

17. The battery according to claim 2, wherein the the sulfur-containing electrode is comprises a sulfur/carbon composite prepared by a melt-diffusion method comprising:
(i) mixing sulfur and Ketjen Black (KB) in a weight ratio of about 1:2 to 2:1 to form a mixture;
(ii) compressing the mixture into a pellet; and
(iii) heating the pellet at about 125° C. to about 180° C. for about 8 hours to 20 hours under a vacuum atmosphere.

18. The battery according to claim 17, wherein the sulfur/carbon composite in the sulfur-containing electrode has a sulfur:carbon mass ratio of about 1:2 to about 2:1.

19. (canceled)

20. The battery according to claim 2, wherein the electrolyte comprises a solid electrolyte material dissolved in a solvent.

21. The battery according to claim 20, wherein the solid electrolyte material is selected from the group consisting of sodium triflate and potassium triflate.

22. The battery according to claim 22, wherein the solvent of the liquid electrolyte is selected from the group consisting of diethylene glycol dimethyl ether, triethylene glycol dimethyl ether, tetraethylene glycol dimethyl ether, diethylene glycol diethyl ether, diethylene glycol dibutyl ether, acetonitrile, propanenitrile, butanenitrile, dimethyl sulfoxide (DMSO), dimethylformamide (DMF), and tetrahydrofuran (THF), propylene carbonate.

23. The battery according to claim 2, wherein the solid electrolyte material has a concentration of about 0.1 M to about 1.0 M based upon a volume of the liquid electrolyte.

24. (canceled)

25. The battery according to claim 2, wherein the battery has a reversible capacity of about 1300 mAh/g to about 1700 mAh/g.

26. The battery according to claim 2, wherein the battery has an overpotential of about 200 mV to about 300 mV during cycles.

27. The battery according to claim 2, wherein the battery has an energy density of about 450 Wh/kg to about 1000 Wh/kg.

28. A method of energy storage, the method comprising:
(i) charging a battery according to claim 2 with an applied electric current;
(ii) discharging the battery.

29. (canceled)
